(19) United States
(12) Patent Application Publication
(10) Pub. No.: US 2026/0264625 A1
(43) Pub. Date: Sep. 10, 2026

(54) VEHICULAR INTERIOR COMPONENT ASSEMBLY

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Kurato KAMADA, Aichi-ken (JP); Aoi HAMAKI, Aichi-ken (JP); Tomoya TAKEUCHI, Aichi-ken (JP); Takuya MUTO, Aichi-ken (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/545,581

(22) Filed: Feb. 20, 2026

(30) Foreign Application Priority Data
Mar. 4, 2025 (JP) 2025-033455

(51) Int. Cl. B60R 13/02; B60R 22/18

(52) U.S. Cl. CPC B60R 13/025; B60R 13/0206; B60R 22/18; B60R 2013/0287; B60R 2013/0293; B60R 2022/1818

(57) ABSTRACT

A vehicular interior component assembly includes a first board including a board-side hole through which a seat belt extends from a vehicular exterior side to a vehicular interior side and a slit that extends from a first edge to the board-side hole and has an opening width being smaller than an opening width of the board-side hole and same as or greater than a thickness of the seat belt, a second board that is disposed continuously to the first board and is disposed next to the first edge, and a seat belt bezel attached to the first board and covering a hole edge portion of the board-side hole and including a bezel-side hole that is communicated with the board-side hole. The second board is disposed to overlap the slit and the seat belt bezel from a vehicular interior side with the bezel-side hole being open toward a vehicular interior space.

### CROSS REFERENCE TO RELATED APPLICATION

This application claims priority from Japanese Patent Application No. 2025-33455 filed on March 4, 2025. The entire contents of the priority application are incorporated herein by reference.

### TECHNICAL FIELD

The present technology described herein relates to a vehicular interior component assembly.

### BACKGROUND

There has been a vehicular interior component including a hole through which a seat belt extends from the vehicular exterior side to the vehicular interior side. One example of such a vehicular interior component is a vehicular pillar with a trim cover. The vehicular pillar includes a trim body and a seat belt bezel. The trim body includes a hole through which a seat belt is inserted (hereinafter referred to as a body-side hole). The seat belt bezel includes a hole through which the seat belt is inserted (hereinafter referred to as a bezel-side hole). The seat belt bezel is fixed to the trim body.

### SUMMARY

The trim body having the above configuration is necessarily mounted on a vehicular body with following steps due to the production matters. The seat belt is pulled out from a winding device mounted on the vehicular body and a seat belt tongue and a seat belt bezel are movably attached to the seat belt. Then, the seat belt is inserted through the body-side hole from the vehicular exterior side. Specifically, one end portion of the seat belt is pulled through the body-side hole to the vehicular interior side first. Subsequently, the seat belt tongue and the seat belt bezel, which are attached to the seat belt, are inserted through the body-side hole and moved from the vehicular exterior side to the vehicular interior side. At this time, the seat belt bezel is oriented so as to be inserted in the body-side hole. Namely, the seat belt bezel is oriented such that the plate surface of the seat belt bezel crosses the plate surface of the trim body. After the seat belt tongue and the seat belt bezel are inserted through the body-side hole to the vehicular interior side, the orientation of the seat belt bezel is changed and attached to the trim body such that the bezel-side hole overlaps the body-side hole from the vehicular interior side.

In the above configuration, the three components of the seat belt, the seat belt tongue, and the seat belt bezel are necessarily inserted through the body-side hole sequentially when mounting the trim body on the vehicular body. Therefore, the mounting of the trim body is not easy and simple. If the seat belt tongue and the seat belt bezel need not be inserted in the body-side hole, the body-side hole can be small enough for receiving only the seat belt. However, to insert the seat belt tongue and the seat belt bezel in the body-side hole, the body-side hole needs to be large enough for receiving the seat belt tongue and the seat belt bezel. According to the increase in the size of the body-side hole, the seat belt bezel that covers the body-side hole also needs to be made larger. This deteriorates the outer appearance.

An object of the present technology described herein is to provide a vehicular interior component assembly with increased workability of mounting a seat belt and good outer appearance.

A vehicular interior component assembly according to the technology described herein includes a first board, a second board, and a seat belt bezel. The first board includes a board-side hole through which a seat belt extends from a vehicular exterior side to a vehicular interior side of the first board. The first board has a first edge and includes a slit that extends from the first edge to the board-side hole. The slit has an opening width that is smaller than an opening width of the board-side hole and is same as or greater than a thickness of the seat belt. The second board is disposed continuously to the first board and is disposed next to the first edge of the first board. The seat belt bezel is attached to the first board and covers a hole edge portion of the board-side hole and includes a bezel-side hole that is communicated with the board-side hole. The second board is disposed to overlap the slit and the seat belt bezel from a vehicular interior side with the bezel-side hole being open toward a vehicular interior space.

### BRIEF DESCRIPTION OF THE DRAWINGS

FIG. 1 is a schematic view illustrating a vehicular interior component assembly and a seat belt according to one embodiment.

FIG. 2 is a perspective view of the vehicular interior component assembly with the seat belt being pulled out.

FIG. 3 is an exploded perspective view illustrating a partition trim and the seat belt that is pulled out from a winding device.

FIG. 4 is an enlarged perspective view of a portion of the partition trim and a seat belt bezel.

FIG. 5 is a perspective view of the partition trim where the seat belt is inserted through a trim side hole.

FIG. 6 is a perspective back side view of the seat belt bezel.

FIG. 7 is an enlarged cross-sectional view illustrating the seat belt bezel that is being fitted in a trim-side hole.

FIG. 8 is an enlarged cross-sectional view illustrating the seat belt bezel that is attached fitted in the trim-side hole.

FIG. 9 is an exploded perspective view illustrating a pillar garnish and the partition trim.

FIG. 10 is an exploded perspective view illustrating the pillar garnish and the partition trim.

FIG. 11 is a perspective view illustrating the pillar garnish and the partition trim that are joined together and seen from a vehicular exterior side.

FIG. 12 is an enlarged perspective view illustrating fitting projections being inserted in a fitting hole.

FIG. 13 is an enlarged cross-sectional view illustrating a portion of the pillar garnish overlapping a portion of the seat belt bezel that does not include a first stopper portion.

FIG. 14 is an enlarged cross-sectional view illustrating a portion of the pillar garnish overlapping a portion of the seat belt bezel that includes the first stopper portion.

### DETAILED DESCRIPTION

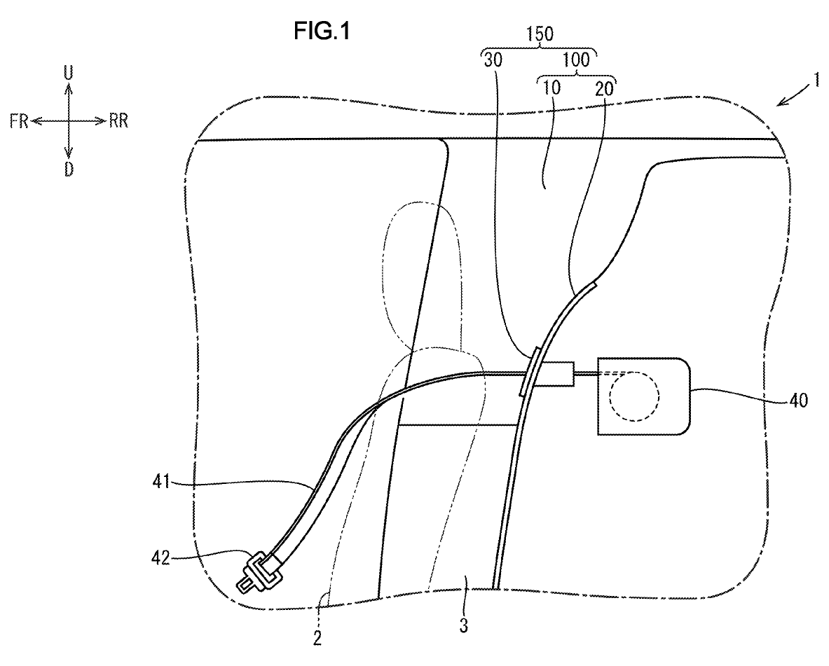

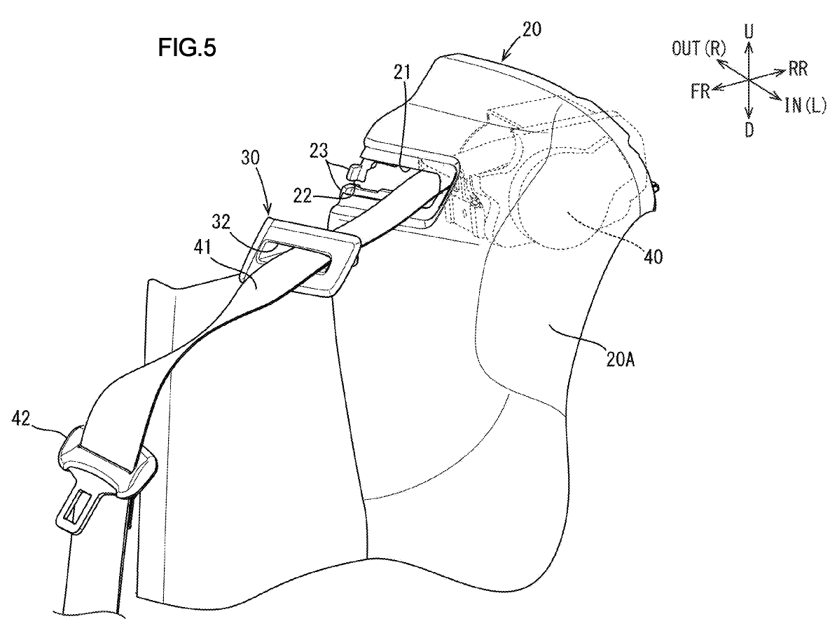

A vehicular interior component assembly 150 of one embodiment will be described with reference to FIGS. 1 to 14. In the drawings, arrows FR and RR point a front side (a vehicle forwarding direction) and a rear side, respectively, arrows In and OUT point a vehicular interior side and a vehicular exterior side, respectively, arrows UP and DW point an upper side and a lower side, respectively. In some of the drawings, arrows L and R point a left side and a right side with respect to the vehicular forwarding direction, respectively.

The vehicular interior component assembly 150 of this embodiment includes a vehicular interior component 100 that is configured as a vehicular interior side design surface of a vehicle 1. In this embodiment, the vehicle 1 is a 2-seater coupe and includes two doors. As illustrated in FIG. 1, the vehicular interior component 100 includes a pillar garnish 10 (a vehicular interior component, a second board) and a partition trim 20 (a vehicular interior component, a first board). The pillar garnish 10 is disposed on a side of a seat back 2 of a front seat and is mounted on a center pillar (a so-called B-pillar), which is configured as a vehicle body, from the vehicular interior side. The partition trim 20 is disposed behind the seat back 2 and continuously from a rear edge of the pillar garnish 10. The partition trim 20 defines a passenger’s space and a rear space. The vehicular interior component assembly 150 further includes a seat belt bezel 30 that is attached to the partition trim 20. In this embodiment, the pillar garnish 10 and the partition trim 20 are disposed such that a plate surface of the pillar garnish 10 and a plate surface of the partition trim 20 cross each other. A side door trim 3 that is configured as a portion of a right wall of a vehicular compartment is disposed below the pillar garnish 10. In the following, a right portion of the vehicle 1 will be described and a left portion has a similar configuration.

### Pillar Garnish 10

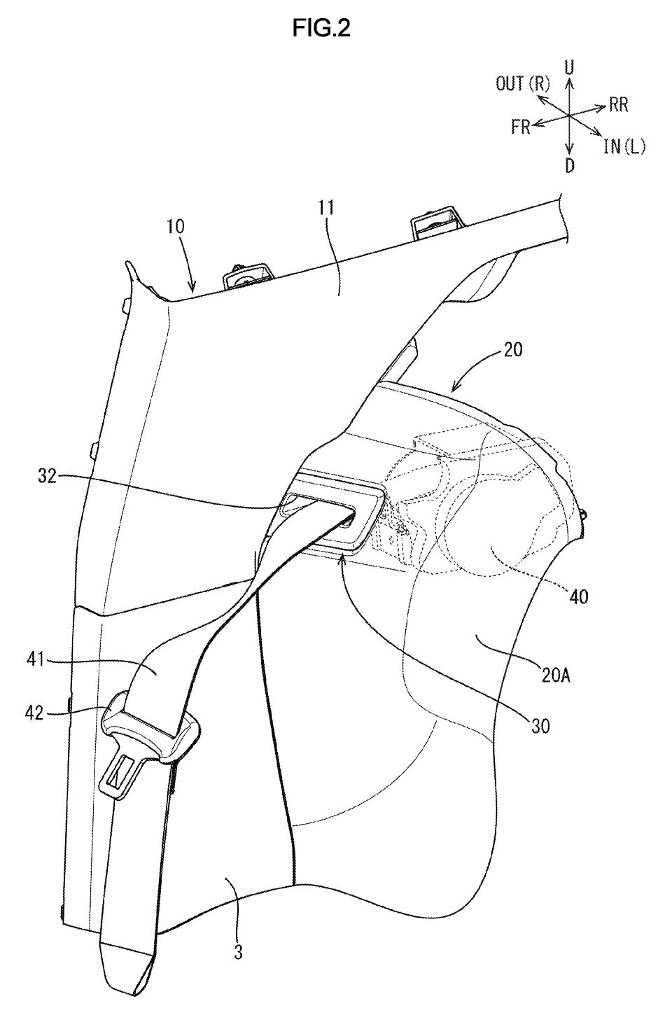

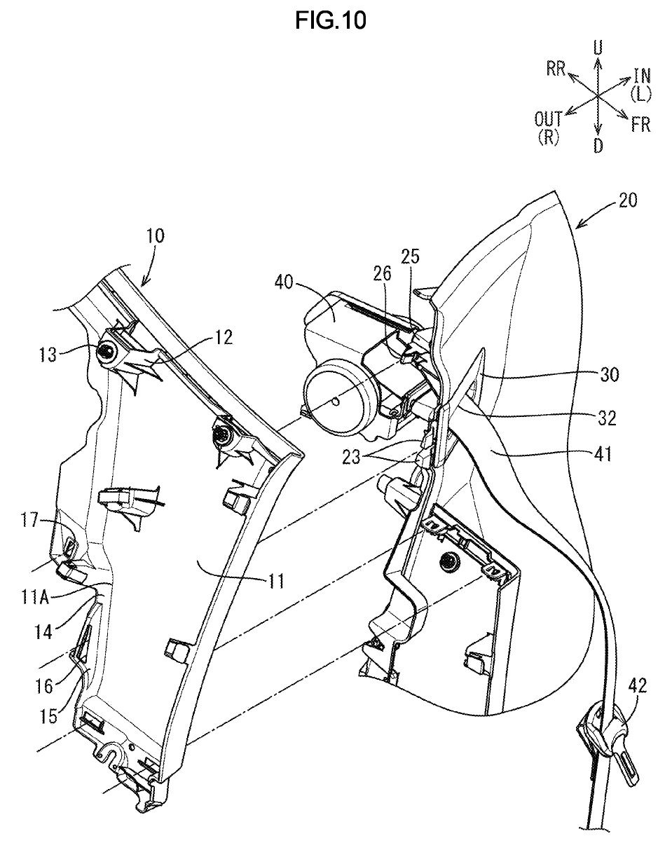

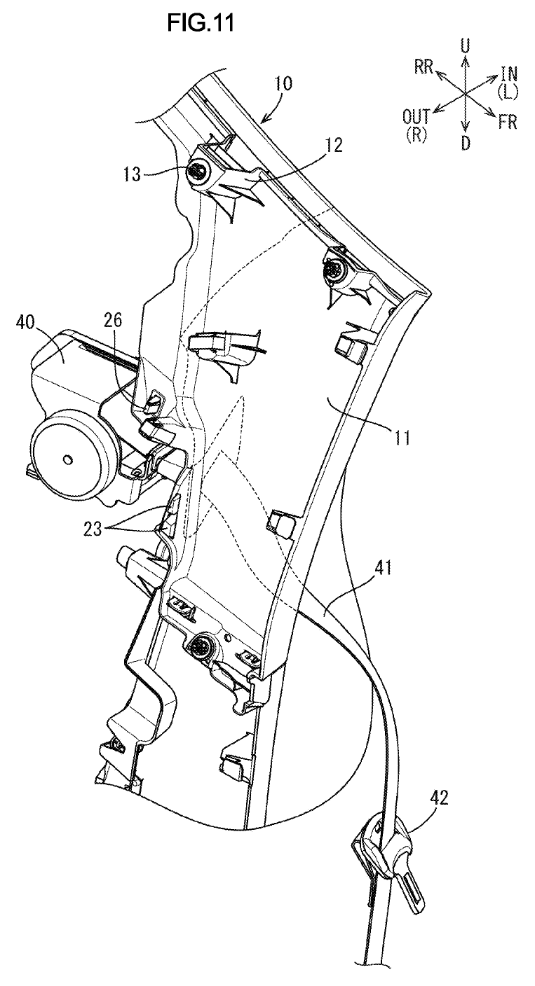

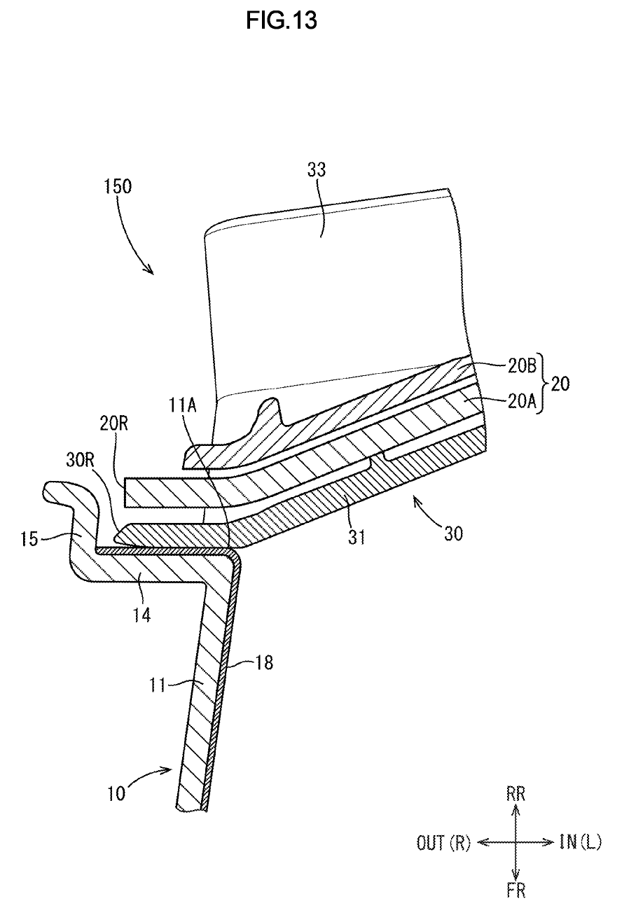

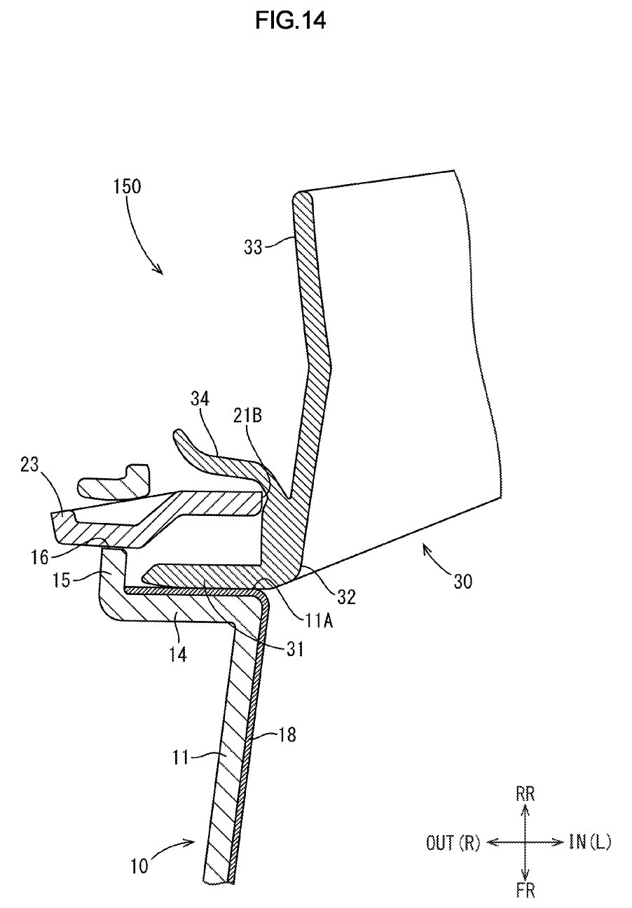

The pillar garnish 10 is made of thermoplastic resin such as polypropylene. As illustrated in FIGS. 1 and 2, the pillar garnish 10 includes a garnish body 11 that is a plate member extending in the vehicular front-rear direction and the upper-bottom direction on the vehicular lateral side. The garnish body 11 increases its width toward the rear side as it extends upward. A clip seat 12 and a clip 13 for attaching the pillar garnish 10 to the center pillar are on the vehicular exterior side of the garnish body 11 (refer to FIGS. 10 and 11). A first extending portion 14 and a second extending portion 15 extend from a rear edge 11A (a second edge) of the garnish body 11. The first extending portion 14 extends from the rear edge 11A toward the vehicular exterior side. The second extending portion 15 extends from a vehicular exterior side edge of the first extending portion 14 toward the rear side (refer to FIGS. 10 and 13). The second extending portion 15 extends along a plate surface of the pillar garnish 10. The rear edge portion of the pillar garnish 10 is bent in a crank shape. The vehicular interior side surface of the garnish body 11 is covered by a skin 18 and this increases interior design of the vehicular compartment. The skin 18 extends such that an end portion of the skin 18 covers at least a portion of the first extending portion 14 (refer to FIGS. 13 and 14).

### Partition Trim 20

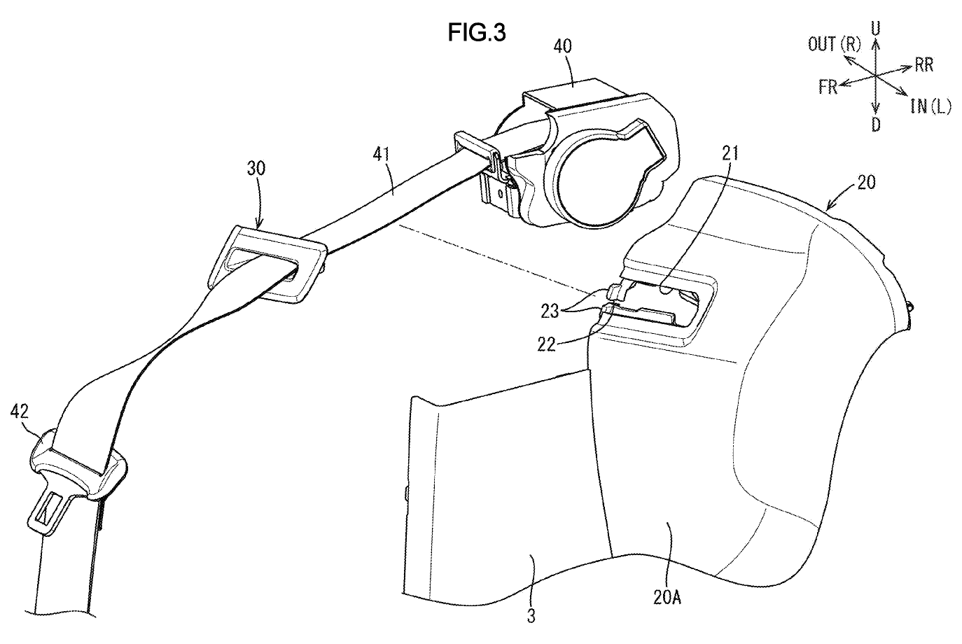

The partition trim 20 is made of thermoplastic resin such as polypropylene. The partition trim 20 is a plate member that has a plate surface facing the front side and the rear side of the vehicle 1 and extends upward from a floor surface of the vehicle 1. As illustrated in FIG. 1, an upper edge portion of the partition trim 20 is gently curved toward the rear side. A trim-side hole 21 (a board-side hole) is formed through a portion of the upper edge portion of the partition trim 20 that is close to the pillar garnish 10. A seat belt 41 that is pulled out from a winding device 40, which is disposed on the vehicular exterior side of (behind) the partition trim 20, is inserted through the trim-side hole 21. The trim-side hole 21 opens obliquely upward. As illustrated in FIGS. 2 and 3, the seat belt bezel 30 is attached to the trim-side hole 21 to cover a hole edge portion 21E of the trim-side hole 21.

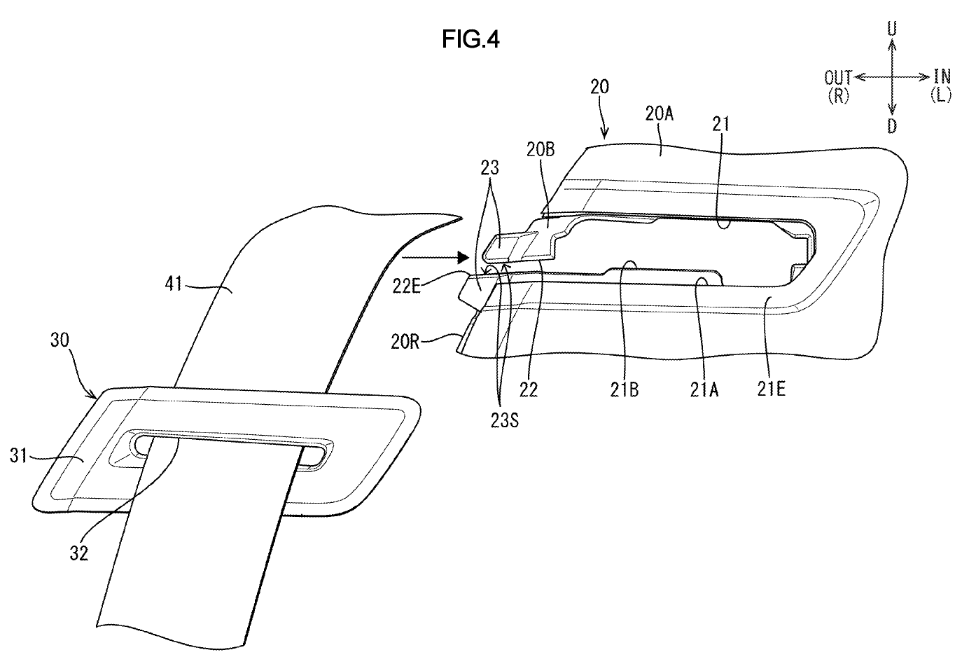

As illustrated in FIGS. 3 and 4, the trim-side hole 21 has a laterally long rectangular shape. The trim-side hole 21 has a long-side dimension (a lateral width) that is greater than the width of the seat belt 41 and a short-side dimension (a vertical width) that is greater than the thickness of the seat belt 41. The short-side dimension of the trim-side hole 21 may be same as the thickness of the seat belt 41. A hole edge of the trim-side hole 21 is continuous to a slit 22 in a vehicular lower right portion (a lower left end portion in FIG. 4). The slit 22 extends from the hole edge of the trim-side hole 21 to a right edge 20R (a first edge) of the partition trim 20. The opening width of the slit 22 measured in the upper-bottom direction is smaller than the vertical width of the trim-side hole 21. The opening width of the slit 22 is set such that the width of the seat belt 41 can be fitted in.

As illustrated in FIG. 4, the partition trim 20 includes a pair of fitting projections 23 that project toward the vehicular exterior side (toward the pillar garnish 10, leftward in FIG. 4) from the right edge 20R. The fitting projections 23 extend continuously from upper and lower hole edges of the slit 22. Opposing surfaces 23S of the fitting projections 23 extend continuously from the upper and lower hole edges of the slit 22 and are configured as a portion of the hole edge of the slit 22. The opposing surfaces 23Sof the fitting projections 23 have a space therebetween. The fitting projections 23 have a box shape opening rearward (the vehicular exterior side). The fitting projections 23 have a block shape having a thickness in the vehicular front rear direction.

The partition trim 20 of this embodiment includes a trim body 20A having a plate shape and a reinforcing member 20B having a plate shape. The reinforcing member 20B is disposed to cover at least a peripheral hole edge portion 21E of the trim-side hole 21 of the trim body 20A from the vehicular exterior side. The trim body 20A has a body-side hole 21A that is a rectangular hole opening rightward. The reinforcing member 20B has a reinforcing member-side hole 21B. The reinforcing member 20B overlaps the trim body 20A such that the hole edge of the reinforcing member 20B projects to the inside of the body-side hole 21A. As illustrated in FIG. 4, the body-side hole 21A and the reinforcing member-side hole 21B overlap and are configured as the trim-side hole 21 and the slit 22.

As illustrated in FIG. 10, the partition trim 20 includes a wall 25 that extends from the vehicular exterior side surface of the partition trim 20 with plate surfaces of the wall 25 facing the right and left sides. The wall 25 is upper than the trim-side hole 21. The wall 25 includes a mounting projection 26 that projects rightward (toward the vehicular exterior side) from the wall 25. The mounting projection 26 is for attaching the partition trim 20 to the pillar garnish 10. The wall 25 and the mounting projection 26 are configured as portions of the reinforcing member 20B.

### Seat Belt Bezel 30

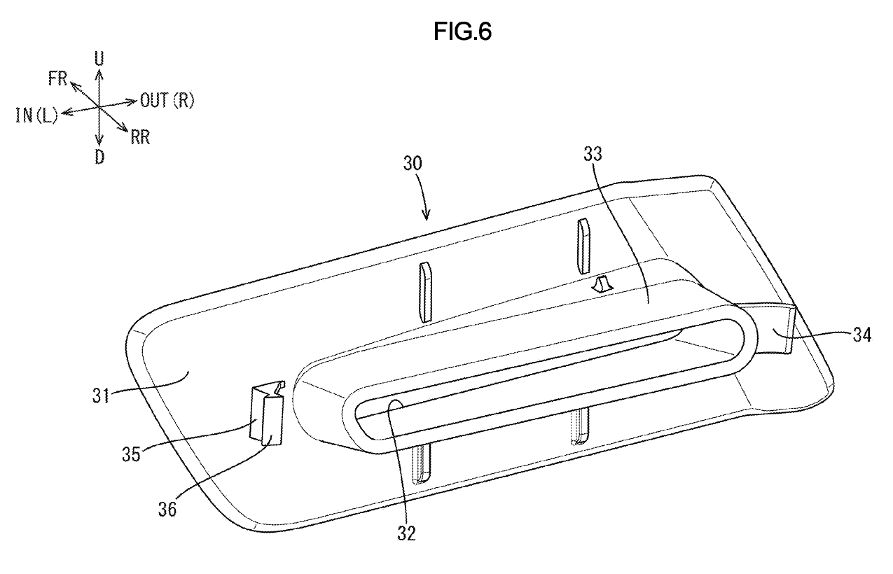

The seat belt bezel 30 is made of thermoplastic resin such as polypropylene (PP), polycarbonate (PC), and ABS resin. The seat belt bezel 30 is attached to the trim-side hole 21 from the vehicular interior side. As illustrated in FIGS. 4 and 6, the seat belt bezel 30 includes a bezel body 31 having a plate shape, a bezel-side hole 32, and a peripheral wall 33. The bezel-side hole 32 is through the bezel body 31 and has an elongated shape. The peripheral wall 33 is a tubular shape and projects from a hole edge of the bezel-side hole 32 toward the vehicular exterior side.

The bezel body 31 has a shape that extends along the vehicular interior side surface of the trim body 20A when the seat belt bezel 30 is attached to the trim-side hole 21. The bezel-side hole 32 is slightly smaller than the trim-side hole 21. Specifically, the long-side dimension of the bezel-side hole 32 is slightly longer than the belt width of the seat belt 41 and the hole width of the bezel-side hole 32 is slightly greater than the thickness of the seat belt 41. The peripheral wall 33 has a dimension so as to be fitted in the trim-side hole 21 of the partition trim 20.

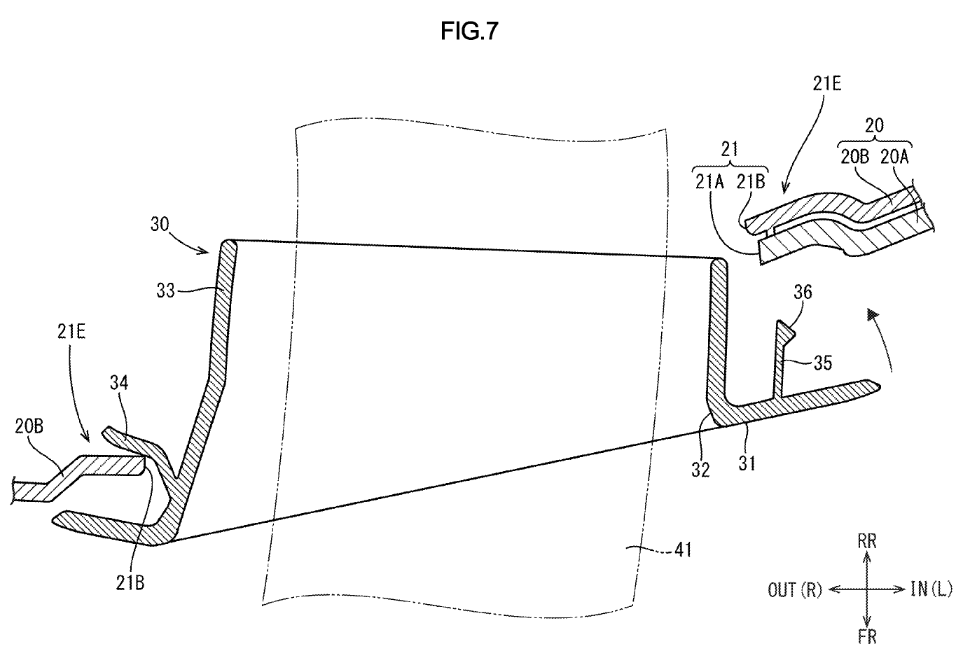

The seat belt bezel 30 includes a first stopper portion 34 and a second stopper portion 35 for fixing the seat belt bezel 30 to the partition trim 20. As illustrated in FIGS. 6 and 7, the first stopper portion 34 extends from a portion (a right portion) of an outer surface of the peripheral wall 33 obliquely toward the rear side. The first stopper portion 34 is configured as a leaf spring. The second stopper portion 35 extends from the vehicular exterior side surface of the bezel body 31 toward the rear side. The second stopper portion 35 is on the left side of the bezel-side hole 32. The second stopper portion 35 and the first stopper portion 34 are on opposite sides of the bezel-side hole 32. The second stopper portion 35 is on an opposite side of the first stopper portion 34 with having the peripheral wall 33 therebetween. A stopper projection 36 is at a distal end of the second stopper portion 35.

### Procedure of Mounting Vehicular Interior Component

Next, a procedure of mounting the pillar garnish 10 and the partition trim 20 on a vehicle body where the winding device 40 is installed will be described.

First, the pillar garnish 10 is fixed to the center pillar of the vehicle body with the clip 13 that is mounted on the vehicular exterior side surface of the garnish body 11.

Next, the seat belt 41 is inserted in the seat belt bezel 30 and a seat belt tongue 42 in this order and the seat belt bezel 30 and the seat belt tongue 42 are movably attached to the seat belt 41 in this order from the winding device 40. Then, the portion of the seat belt 41 that is between the seat belt bezel 30 and the winding device 40 is fitted in the trim-side hole 21 through the slit 22 as illustrated in FIGS. 3 to 5. The seat belt 41 is moved along the hole edge of the slit 22 in the belt width direction and inserted in the trim-side hole 21 easily. With the seat belt 41 being inserted in the trim-side hole 21, the seat belt bezel 30 and the seat belt tongue 42, which are attached to the seat belt 41, are on the vehicular interior side of the partition trim 20.

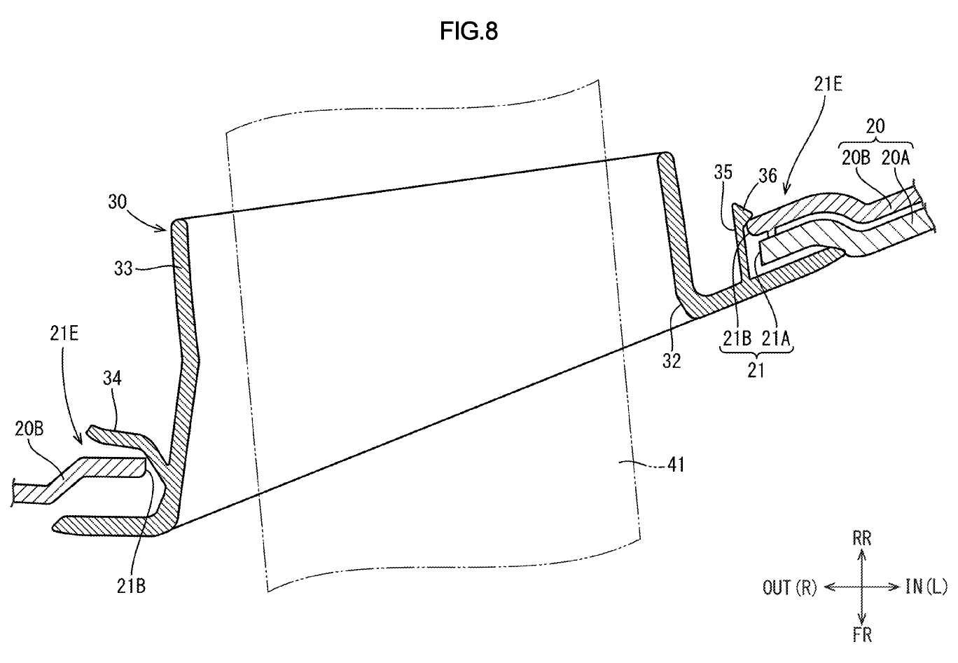

Next, the seat belt bezel 30 that is disposed on the vehicular interior side of the partition trim 20 is attached to the trim-side hole 21 by moving the seat belt bezel 30 along the seat belt 41 toward the trim-side hole 21. Specifically, at first, as illustrated in FIG. 7, the portion of the peripheral wall 33 having the first stopper portion 34 is inserted in the trim-side hole 21 and the first stopper portion 34 is inserted to the rear side of the hole edge portion 21E (the reinforcing member 20B). Thereafter, the portion of the bezel body 31 having the second stopper portion 35 is pressed into the trim-side hole 21. Then, the stopper projection 36 is pressed to the hole edge portion 21E of the trim-side hole 21 and the second stopper portion 35 is pushed into the trim-side hole 21 toward the rear side with being elastically deformed. When the stopper projection 36 is inserted through the trim-side hole 21 and moved to the rear side of the hole edge portion 21E of the trim-side hole 21, the second stopper portion 35 elastically restores its original shape. Thus, as illustrated in FIG. 8, the stopper projection 36 of the second stopper portion 35 is contacted with the hole edge portion 21E of the trim-side hole 21 from the vehicular exterior side and the seat belt bezel 30 is attached to the partition trim 20.

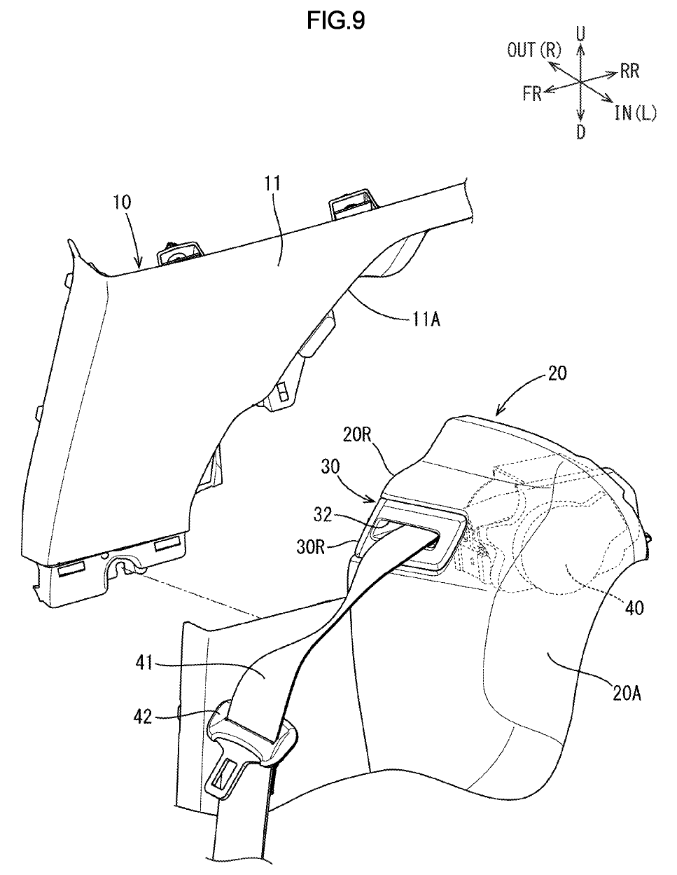

In the state illustrated in FIG. 8, a right edge 30R (an edge on the left side in FIG. 9, a third edge) of the seat belt bezel 30 and the right edge 20R of the partition trim 20 are aligned with each other and substantially on the same line. The right edge 30R is an edge of the portion of the seat belt bezel 30 that overlaps slit 22. The right edges 20R, 30R are next to the rear edge 11A of the garnish body 11. As illustrated in FIG. 10, the pair of fitting projections 23 of the partition trim 20 project rightward (toward the vehicular exterior side) from the right edge 30R of the seat belt bezel 30.

Next, the partition trim 20 to which the seat belt 41 and the seat belt bezel 30 are attached is fitted to the pillar garnish 10. As previously described, the rear edge portion of the pillar garnish 10 is bent in a crank shape toward the vehicular exterior side. As illustrated in FIG. 14, the second extending portion 15 extends substantially along the garnish body 11. Namely, the second extending portion 15 extends in the direction that crosses the plate surface of the partition trim 20, which is disposed to cross the garnish body 11. As illustrated in FIGS. 10, 12, and 14, the second extending portion 15 includes a fitting hole 16 through which the pair of fitting projections 23 are inserted. The fitting hole 16 is in a portion of the second extending portion 15 corresponding to the fitting projections 23 with the pillar garnish 10 and the partition trim 20 being arranged in the correct position.

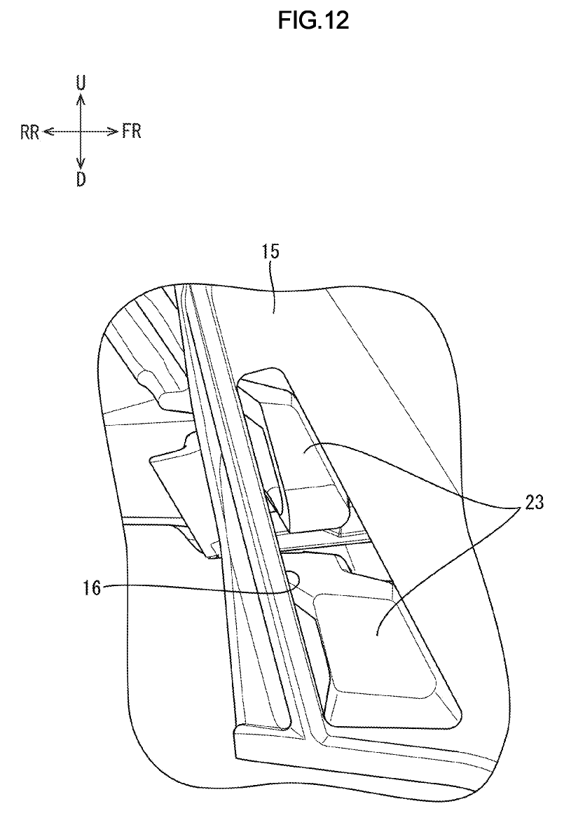

FIG. 12 is an enlarged perspective view illustrating the fitting projections 23 that are fitted in the fitting hole 16. The fitting hole 16 is formed with a size such that the fitting projections 23 do not move farther away from each other in the upper-bottom direction and do not move in the front-rear direction. Namely, with the fitting projections 23 being fitted in the fitting hole 16 in the second extending portion 15 of the pillar garnish 10, the partition trim 20 is positioned with respect to the pillar garnish 10 and maintains the shape thereof. With the partition trim 20 maintaining the shape thereof, the fitting projections 23 are in the state so as not to move farther away from each other.

As illustrated in FIG. 10, the second extending portion 15 includes a mounting hole 17 above the fitting hole 16. The mounting projection 26 of the partition trim 20 is fitted in the mounting hole 17 (refer to FIGS. 10 and 11). The mounting projection 26 is inserted in the mounting hole 17 and stopped by the hole edge of the mounting hole 17 and the partition trim 20 is fixed to the pillar garnish 10 as illustrated in FIGS. 10 and 11.

With the partition trim 20 and the pillar garnish 10 being joined together, the rear edge 11A of the garnish body 11 is contacted with the vehicular interior side surfaces of the partition trim 20 and the seat belt bezel 30 as illustrated in FIGS. 2, 13, and 14. Accordingly, the outer appearance of border portions of the partition trim 20, the seat belt bezel 30, and the pillar garnish 10 is improved.

The rear edge portion of the pillar garnish 10 is bent in a crank shape. As illustrated in FIGS. 13 and 14, the first extending portion 14 overlaps the partition trim 20 and the seat belt bezel 30 from the vehicular interior side. The first extending portion 14 overlaps the vehicular interior side surfaces of the partition trim 20 and the seat belt bezel 30. At least a portion of the first extending portion 14 is covered by the skin 18 that extends from the garnish body 11. Therefore, noise is less likely to be caused in the overlapping portion of the first extending portion 14 and the partition trim 20 and the seat belt bezel 30 due to the vibration during the vehicle’s running.

The second extending portion 15 continuously extends from the vehicular exterior end of the first extending portion 14 so as to be bent rearward. Therefore, even if a gap is created between the garnish body 11 and each of the partition trim 20 and the seat belt bezel 30 due to the mounting errors, the second extending portion 15 covers the gap and the vehicular exterior side space (inner space of the pillar) of the pillar garnish 10 is less likely to be seen from the vehicular interior side.

Furthermore, the fitting hole 16 is in the second extending portion 15 as illustrated in FIG. 14.

### Operations and Effects

Next, operations and effects will be described. The vehicular interior component assembly 150 of this embodiment includes the partition trim 20, the pillar garnish 10 that is disposed continuously next to the partition trim 20, and the seat belt bezel 30. The partition trim 20 includes the trim-side hole 21 and the slit 22. The seat belt 41 extends through the trim-side hole 21 from the vehicular exterior side of the partition trim 20 to the vehicular interior side. The slit 22 extends from the right edge 20R of the partition trim 20 that is next to the pillar garnish 10 to the trim-side hole 21. The slit 22 is open at the right edge 20R of the partition trim 20. The opening of the slit 22 is defined as an edge-side opening 22E. The edge-side opening 22E opens toward the pillar garnish 10. The hole width of the slit 22 is smaller than the hole width of the trim-side hole 21. The hole width of the slit 22 is defined such the seat belt 41 can be inserted in the slit 22 with respect to the width direction of the seat belt 41. The hole width of the slit 22 (the edge-side opening 22E) is same as or greater than a thickness of the seat belt 41. The seat belt bezel 30 is attached to the partition trim 20 to cover the trim-side hole 21 and the hole edge portion 21E from the vehicular interior side. The seat belt bezel 30 includes the bezel-side hole 32 that is communicated with the trim-side hole 21. The pillar garnish 10 is disposed to overlap the slit 22 and a portion of the seat belt bezel 30 from the vehicular interior side with the bezel-side hole 32 being exposed to be open toward a vehicular interior space.

With the above configuration, the seat belt 41 is pulled out from the winding device 40, which is disposed on the vehicular exterior side of the partition trim 20, and the seat belt 41 where the seat belt bezel 30 and the seat belt tongue 42 are movably attached previously is inserted into the slit 22 in the width direction of the seat belt 41 with the seat belt bezel 30 being disposed on the vehicular interior side of the partition trim 20. The seat belt 41 is slid into the slit 22 along the width direction of the seat belt 41. The seat belt 41 is not inserted in the trim-side hole 21 from the distal end of the seat belt 41 along the elongated direction of the seat belt 41. The seat belt 41 and the seat belt bezel 30 need not be inserted through the trim-side hole 21 separately from the vehicular exterior side of the partition trim 20. Therefore, the seat belt 41 can be mounted on the partition trim 20 easily.

The seat belt bezel 30 need not be inserted through the trim-side hole 21. Therefore, the size of the trim-side hole 21 can be determined so that only the seat belt 41 can pass through. Accordingly, the seat belt bezel 30 that covers the hole edge portion 21E of the trim-side hole 21 from the vehicular interior side can be reduced in size. This improves design of the vehicular interior.

After the seat belt 41 is inserted through the slit 22 to the trim-side hole 21, the slit 22 is covered by the seat belt bezel 30 and the pillar garnish 10 from the vehicular interior side. Therefore, the slit 22 is not seen from the vehicular interior side and does not deteriorate the design of the vehicular interior.

The fitting projections 23 projecting from the right edge 20R of the partition trim 20 have the opposing surfaces 23S that are opposite each other. The opposing surfaces 23S of the fitting projections 23 extend continuously from the hole edges of the slit 22 and are configured as a portion of the slit 22. The fitting projections 23 are fitted in the fitting hole 16 of the pillar garnish 10 so as not to move to be farther away from each other.

With the above configuration, with the fitting of the fitting projections 23 and the fitting hole 16, the partition trim 20 and the pillar garnish 10 can be positioned with respect to each other. Even if a large force is applied to the partition trim 20 that is fitted to the pillar garnish 10, the slit 22 and the trim-side hole 21 of the partition trim 20 are less likely to be deformed to open widely because of the fitting of the fitting projections 23 and the fitting hole 16.

The partition trim 20 and the pillar garnish 10 that are joined together are arranged such that the plate surfaces of the partition trim 20 and the pillar garnish 10 cross each other. The garnish body 11 of the pillar garnish 10 has the rear edge 11A that is disposed next to the partition trim 20. The garnish body 11 includes the first extending portion 14 and the second extending portion 15 at the rear edge 11A. The first extending portion 14 extends from the rear edge 11A toward the vehicular exterior side and is disposed to overlap the vehicular interior side surface of the partition trim 20. The second extending portion 15 extends from the vehicular exterior side edge of the first extending portion 14 toward the partition trim 20 (the rear side). The fitting hole 16 is in the second extending portion 15.

With the partition trim 20 and the pillar garnish 10 being arranged such that the plate surfaces of the partition trim 20 and the pillar garnish 10 cross each other, a gap may be created between the partition trim 20 and the pillar garnish 10 due to a fitting error. In this embodiment, the second extending portion 15 extending from the vehicular exterior side edge of the first extending portion 14 toward the partition trim 20 can cover the gap. Therefore, any component disposed on the vehicular exterior side of the vehicular interior component is less likely to be seen through the gap.

The portion (the first extending portion 14) of the pillar garnish 10 that overlaps the seat belt bezel 30 is covered by the skin 18. Therefore, noise is less likely to be caused in the overlapping portions of the pillar garnish 10 and the seat belt bezel 30 due to vibrations caused while the vehicle’s running.

### Other Embodiments

The technology described herein is not limited to the embodiment described above with reference to the drawings. The technology described herein may be modified within the technical scope. The following embodiments may be included in the technical scope.

(1) In the above embodiment, the pillar garnish 10 and the partition trim 20 are arranged such that the plate surfaces thereof cross each other. However, the partition trim 20 and the pillar garnish 10 may be arranged next to each other along one direction.

(2) In the above embodiment, the opposing surfaces 23S of the fitting projections 23, which project from the right edge 20R of the partition trim 20 toward the pillar garnish 10, are configured as a portion of the hole edge of the slit 22. The configuration without including the fitting projections is included in the technical scope.

(3) The skin 18 may not be included.

(4) In the above embodiment, the partition trim 20 includes the trim body 20A and the reinforcing member 20B that is disposed to overlap the trim body 20A on the vehicular exterior side; however, the partition trim may be one plate member without including the reinforcing member.

1. A vehicular interior component assembly comprising:
a first board including a board-side hole through which a seat belt extends from a vehicular exterior side to a vehicular interior side of the first board, the first board having a first edge and including a slit that extends from the first edge to the board-side hole, the slit having an opening width that is smaller than an opening width of the board-side hole and is same as or greater than a thickness of the seat belt;
a second board that is disposed continuously to the first board and is disposed next to the first edge of the first board; and
a seat belt bezel attached to the first board and covering a hole edge portion of the board-side hole and including a bezel-side hole that is communicated with the board-side hole, wherein
the second board is disposed to overlap the slit and the seat belt bezel from a vehicular interior side with the bezel-side hole being open toward a vehicular interior space.

2. The vehicular interior component assembly according to claim 1, wherein
the first board includes at least two projection portions that project from the first edge toward the second board,
the at least two projection portions have opposing surfaces that are opposite each other,
the opposing surfaces extend continuously from hole edges of the slit, and
the second board includes a fitting hole in which the at least two projection portions are fitted so as not to move to be farther away from each other.

3. The vehicular interior component assembly according to claim 2, wherein
the first board and the second board are disposed such that a plate surface of the first board crosses a second surface of the second board,
the second board has a second edge that is next to the first board,
the second board includes a first extending portion and a second extending portion at the second edge,
the first extending portion extends toward a vehicular exterior side and overlaps a vehicular interior side surface of the first board,
the second extending portion extends from an extending end of the first extending portion toward the first board, and
the second extending portion includes the fitting hole.

4. The vehicular interior component assembly according to claim 1, wherein a portion of the second board overlapping the seat belt bezel is covered by a skin.

5. The vehicular interior component assembly according to claim 1, wherein the slit has an opening that opens toward the second board and through which the seat belt is inserted.

6. The vehicular interior component assembly according to claim 3, wherein the second extending portion extends along the plate surface of the second board.

7. The vehicular interior component assembly according to claim 1, wherein
the seat belt bezel includes an overlapping portion overlapping the slit,
the overlapping portion has a third edge, and
the third edge of the seat belt bezel and the first edge of the first board are aligned with each other.
